(19) United States
(12) Patent Application Publication
(10) Pub. No.: US 2026/0316840 A1
(43) Pub. Date: Oct. 15, 2026

(54) VEHICLE PANEL, VEHICLE PANEL HAVING A WRAP EDGE RECEIVING CHANNEL, AND METHOD OF APPLYING A WRAP TO A VEHICLE PANEL HAVING A WRAP EDGE RECEIVING CHANNEL

(71) Applicant: Re:Car Inc., Troy, MI (US)

(72) Inventors: Gustavo Bizyk, Los Angeles, CA (US); Mark Stubbs, Laguna Beach, CA (US); Julien Fesquet, Beverly Hills, CA (US); Tisha Johnson, Douglas, MI (US); Henri Kavaja, Laguna Niguel, CA (US)

(21) Appl. No.: 19/644,751

(22) Filed: Apr. 10, 2026

Related U.S. Application Data
(60) Provisional application No. 63/786,768, filed on Apr. 10, 2025.

(51) Int. Cl. B62D 25/02; B32B 3/30; B32B 7/12; B32B 15/08; B60J 5/04; B60J 5/10; B60P 3/42; B62D 25/12; B62D 25/16; B62D 27/00; B62D 29/00; B62D 33/023

(52) U.S. Cl. CPC B62D 25/02; B32B 3/30; B32B 7/12; B32B 15/08; B60J 5/048; B60J 5/101; B60P 3/42; B62D 25/12; B62D 25/16; B62D 27/00; B62D 29/001; B62D 33/023; B32B 2250/02; B32B 2605/00

(57) ABSTRACT

A combination of a vehicle panel, a first wrap sheet, and a second wrap sheet, the vehicle panel having a wrap edge receiving channel extending at least partially along a width of the panel and separating the panel into a first panel portion on one side of the channel and a second panel portion on another side of the channel, the wrap edge receiving channel is configured to receive a first edge of the first wrap sheet and a second edge of the second wrap sheet.

### CROSS-REFERENCE TO RELATED APPLICATIONS

This application claims priority to U.S. 63/786,768 filed on Apr. 10, 2025, the entirety of which is hereby incorporated by reference herein for all purposes.

### FIELD

These teachings relate to a vehicle panel, a vehicle panel having a wrap edge receiving channel, a vehicle having a vehicle panel having a wrap edge receiving channel, and a method of applying a wrap to a vehicle panel having a wrap edge receiving channel.

### BACKGROUND

Some vehicle owners apply a graphic sheet or wrap to one or more vehicle panels for various reasons including customizing the appearance of the vehicle and protecting the vehicle finish against scratches, rock chips, UV rays, and minor abrasions.

However, applying a graphic sheet or wrap to a vehicle panel can be time consuming and require care and precision to achieve a professional-looking result. For example, application of a graphic sheet or wrap onto a vehicle panel having multiple degrees of curvature may result in formation of creases in the wrap material. Additionally, when multiple wrap sheets are used, aligning adjacent wrap edges may be difficult, and visible seams between the wrap sheets may be aesthetically undesirable. After installation, exposed edges of one or more wrap sheets may remain visible to the owner or a bystander and may be prone to lifting or separation from the vehicle panel, particularly after prolonged exposure to environmental conditions such as sunlight, rain, and car wash operations, thereby causing additional aesthetic and/or coverage issues.

Accordingly, improvements in this area are desirable. In particular, it may be advantageous to provide a vehicle panel having one or more features configured to facilitate application of one or more wrap sheets. It may further be advantageous to provide a vehicle panel having a structure configured to receive and position edges of multiple wrap sheets and to conceal such edges from an observer and/or the surrounding environment.

### SUMMARY

These teachings provide a vehicle panel having one or more features to assist a user in applying a graphic sheet or wrap to the panel, which may make applying the graphic sheet or wrap easier and less intimidating. The one or more features of the vehicle panel may function to conceal an edge of a graphic sheet or wrap to an observer and/or the surrounding environment, which may advantageously improve the aesthetic appearance of the wrap and/or vehicle. The feature may be one or more wrap edge receiving channels. These teachings provide a vehicle having a vehicle panel having a wrap edge receiving channel, and a method of applying a wrap to a vehicle panel having a wrap edge receiving channel.

A vehicle panel is provided with one or more specially configured channels that receive edges of one or more wrap sheets. The channel may extend along at least a portion of the panel and separates the panel into distinct regions. During installation, edges of adjacent wrap sheets are positioned within the channel, which helps guide placement, improve alignment, and reduce the likelihood of creasing when applying the wrap sheets to contoured surfaces.

The channel is shaped to receive and retain the wrap edges and may include angled wall surfaces that assist in directing the edges into position. By locating the edges within the channel, the edges may be less visible to an observer and may be less prone to lifting or separation due to environmental exposure. The channel may accommodate different configurations, including spaced edges, overlapping edges, or multiple wrap sheets meeting within a single channel.

In some implementations, the vehicle panel may be incorporated into various vehicle components such as doors, tailgates, fenders, or hoods. Multiple channels may be provided on a single panel to support complex wrap layouts involving multiple wrap sheets.

A method is also provided in which wrap sheets are applied to the vehicle panel and edges of the wrap sheets are inserted into the channel to improve installation quality and durability.

One or more of the following references may be relevant to the subject matter disclosed herein, all of which are hereby incorporated by reference in their entities for all purposes: US 2022/0227315A1, US 2018/0079187A1, U.S. Pat. No. 11,420,427B2, US 2013/0237130A1, U.S. Pat. No 10,981,371B2, U.S. Pat. No. 10,550,297B2, US 2015/0086782A1.

A combination is also disclosed that includes one a vehicle panel, a first wrap sheet, and a second wrap sheet, the combination being adaptable for use on a vehicle that is reconfigurable between a pickup truck configuration and a sport utility (SUV) configuration, the vehicle includes a frame comprising a front region that is located generally over a pair of front wheels of the vehicle and a rear region that is located generally over a pair of rear wheels of the vehicle, rear region having a pair of opposing bed walls and a rear floor, wherein frame comprises one or more frame fastening devices; a rear enclosure assembly configured to attach to the one or more preexisting fasteners on the frame to reconfigure the vehicle from the pickup truck configuration to the SUV configuration, the rear enclosure assembly comprising: i) a roll bar assembly comprising a hoop structure having a pair of spaced apart pillars, an upper cross bar connected to upper regions of the pillars, and optionally a lower cross bar; and ii) one or more rear passenger seats configured for attachment to the roll bar assembly; the hoop structure is attached to the opposing bed walls and/or the rear floor of the frame.

### BRIEF DESCRIPTION OF THE DRAWINGS

FIG. 1A is a rear perspective view of a vehicle having one or more vehicle panels.

FIG. 1B is a front perspective view of a vehicle having one or more vehicle panels.

FIG. 2A is a perspective view of a portion of a vehicle panel having a wrap edge receiving channel.

FIG. 2B is a perspective view of a portion of a vehicle panel having a wrap edge receiving channel.

FIG. 3A is a perspective view of a portion of a vehicle panel having a wrap edge receiving channel, and an edge of a wrap sheet is received or located within the wrap edge receiving channel.

FIG. 3B is a perspective view of a portion of a vehicle panel having a wrap edge receiving channel, and edges of adjacent wrap sheets are received or located within the wrap edge receiving channel.

FIG. 3C is a perspective view of a portion of a vehicle panel having a wrap edge receiving channel, and edges of adjacent wrap sheets are received or located within the wrap edge receiving channel.

FIG. 4 is a perspective view of a vehicle panel that is a hood that includes a plurality of wrap edge receiving channels.

FIG. 5 is a perspective view of a vehicle panel that is a tailgate that includes a plurality of wrap edge receiving channels.

FIG. 6 is a front perspective view of a vehicle having one or more vehicle panels.

FIG. 7 is a cross sectional view of a vehicle panel.

FIG. 8 is a cross sectional view of a vehicle panel.

### DETAILED DESCRIPTION

These teachings describe a vehicle panel, a vehicle panel having one or more wrap edge receiving channels, a vehicle having one or more vehicle panels having one or more wrap edge receiving channels, and a method of applying a wrap to one or more vehicle panels having one or more wrap edge receiving channels.

By way of summary, the vehicle panel may be part of or attached to any suitable vehicle. Such vehicles may include land-based vehicles, for example passenger cars, trucks, sport utility vehicles (SUVs), vans, buses, motorcycles, all-terrain vehicles (ATVs), utility task vehicles (UTVs), side-by-side vehicles, recreational vehicles (RVs), construction vehicles, agricultural vehicles, and trailers. The vehicle panel may also be incorporated into watercraft, including boats, personal watercraft, ships, and other marine vessels. In addition, the vehicle panel may be used with aircraft, such as airplanes, helicopters, drones, and other aerial vehicles. The disclosed concepts may further be applicable to other transport or recreational platforms where surface panels are used, regardless of propulsion type or operating environment.

The vehicle panel may be used with or may include one or more of the vehicle panels illustrated and described in the reconfigurable vehicle in U.S. 63/785,542 filed on Apr. 8, 2025, U.S. 63/788,545 filed on Apr. 14, 2025, U.S. 63/792,518 filed on Apr. 22, 2025, and/or U.S. patent application Ser. No. 19/642,294 filed on Apr. 8, 2026, the entireties of which are all hereby incorporated by reference herein for all purposes.

In one implementation, the vehicle may be a vehicle that can be reconfigured from a first vehicle configuration to a second vehicle configuration. The vehicle can be reconfigured back to the first vehicle configuration. In other words, the vehicle has a reversible configurable structure. In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

The vehicle comprises a vehicle frame that comprises one or more preexisting frame fastening devices; a rear enclosure assembly configured to attach to the one or more preexisting fasteners on the frame to reconfigure the vehicle from the pickup truck configuration to the SUV configuration, the rear enclosure assembly comprising: a roll bar assembly comprising a hoop structure having a pair of spaced apart pillars, an upper cross bar connected to upper regions of the pillars, and an optional lower cross bar; and one or more rear passenger seats configured for attachment to the roll bar assembly and/or vehicle frame.

As used herein, “preexisting” refers to fastening features incorporated into or on the vehicle frame by the original vehicle manufacturer during original manufacture and prior to the vehicle being placed into service. For example, the plurality of preexisting frame fastening devices comprise threaded fasteners, weld nuts, threaded bores, or combinations thereof installed prior to reconfiguration of the vehicle. The rear enclosure assembly is attachable to the vehicle frame without welding, bonding, cutting, drilling, or grinding the vehicle frame. The rear enclosure assembly is removable from the vehicle frame to return the vehicle to the pickup truck configuration using the plurality of preexisting frame fastening devices.

One of the vehicle configurations (e.g., first vehicle configuration or second vehicle configuration) may be a pickup truck or pickup truck configuration. The other vehicle configuration (e.g., first vehicle configuration or second vehicle configuration) may be a sport utility vehicle (SUV) or SUV configuration.

A “pickup truck” configuration includes a vehicle that may be a light, medium-duty or heavy-duty truck. The pickup truck configuration may include a vehicle having an enclosed cab or cockpit (for at least a driver and at least one occupant) and an open cargo area, namely a bed, located in the rear portion of the vehicle and being operable for storing and/or transporting cargo. A pickup truck configuration may be a vehicle that does not include a C-pillar, e.g., does not include a C-pillar that defines part of a passenger cab. A pickup truck configuration may be a vehicle that does not include a D-pillar. A pickup truck configuration may be a vehicle that has a removable bulk head panel and rear window or glass assembly that can be completely removed or separated from the vehicle.

A “sport utility vehicle” includes a vehicle that may be a light, medium-duty or heavy-duty vehicle including an enclosed cab (for at least a driver and at least one and preferably a plurality of occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C-and D-pillars may be added.

The vehicle panel may be any panel of a body of a vehicle. The vehicle panel may be a horizontal panel, such as a hood panel, a roof panel, one or more panels that cover a cargo area of the vehicle (e.g., an SUV kit or cargo cover and/or a tonneau cover), or a trunk lid. The vehicle panel may be a vertical panel, such as a door panel, a front fender, a rear fender, a tailgate, a hatch, or a liftgate. The vehicle panel may include one or more pillar covers or appliques, including A-pillar, B-pillar, C-pillar, and/or D-pillar covers or appliques.

The vehicle panel may further include exterior body panels such as quarter panels, rocker panels, side skirts, bed panels, bed side walls, bed caps, bumper covers (front and/or rear), fascia panels, grille surrounds, mirror housings, and spoiler elements.

In some configurations, a vehicle panel may be an interior panel that faces an interior or cockpit region of the vehicle. For example, a vehicle panel at the interior may be a door panel (e.g., a front or rear door panel, a driver-side or passenger-side door panel, etc.). The vehicle panel may additionally or alternatively include other interior panels, such as dashboard panels, instrument panel surfaces, center console panels, trim panels, seat back panels, pillar trim panels, and other interior-facing surfaces.

The vehicle panel (inner or outer vehicle panel) may have an outer panel substrate. An outer panel substrate may be part of a vehicle panel that faces an exterior or environment surrounding the vehicle. In the case of an interior vehicle panel, the outer panel substrate may be the part of the panel that faces an interior or cockpit of the vehicle.

The outer panel substrate of the vehicle panel may be supported by, positioned against, and/or attached to a frame or panel support member. The frame or panel support member may be formed from metal, plastic, composite materials, or combinations thereof. In some configurations, the frame or panel support member may be attached to a structural portion of the vehicle, such as a vehicle frame or body structure.

The frame or panel support member may be formed from one or more materials including metals (e.g., steel, aluminum), polymers, reinforced plastics, fiber-reinforced composites, or combinations thereof. In some configurations, the frame or panel support member may be directly or indirectly coupled to a structural portion of the vehicle, such as a vehicle frame, body-in-white structure, unibody structure, or other load-bearing vehicle architecture. The panel support member may function to increase rigidity, stiffness, and dimensional stability of the outer panel substrate. For example, the panel support member may reduce flexing, vibration, or deformation of the outer panel substrate during vehicle operation, environmental loading, or aerodynamic forces. The panel support member may contribute to energy absorption and load transfer during impact events by directing forces toward structural portions of the vehicle.

A back side (e.g., B-side) of the outer panel substrate or polymeric body may be attached to a panel frame or panel support member and/or to the vehicle the frame.

In some configurations, the outer panel substrate may be removably attached to the panel frame or panel support member and/or to the vehicle or the frame via one or more mechanical fasteners, such as screws, bolts, pins, clips, and/or similar attachment elements.

For example, one or more vehicle panels, such as fenders or door panels, may be secured to the frame or support member in a manner that allows the outer panel substrate to be removed and replaced without damaging the frame or support member. This may be advantageous in situations where the outer panel substrate is damaged (e.g., scratched, dented, or otherwise impacted), allowing replacement of the outer panel substrate without requiring replacement of the entire vehicle panel assembly.

The one or more mechanical fasteners may include bolts, screws, pegs, projections, clips, U-clips, C-clips, pins, posts, latches, clamps, hooks, quick connect fasteners, quarter turn fasteners, bores, slots, apertures, threaded bores or slots, weld nuts, self-clinching nuts, blind rivet nuts, rivets, or other threaded inserts, flanges, or any combination thereof.

In some configurations, the outer panel substrate or polymeric body may be permanently attached to a panel frame or panel support member and/or to the vehicle or the frame via one or more permanent fasteners such as adhesives, welding, etc. For example, one or more of the hood, roof, and/or tailgate panels may be attached to a panel frame or panel support member and/or to the vehicle the frame via one or more permanent fasteners so the one or more vehicle panels cannot be easily removed from the frame or panel support member without mechanically or permanently destroying the vehicle panel by, for example, cutting, milling, grinding, etc.

In one example, a polymeric film wrap or wrap sheet may be applied on an outer panel substrate, which may be the polyolefin substrate. The wrap sheet may include a film having an outer surface and inner surface. The inner surface may comprise an adhesive layer that contacts the outer surface of the substrate. The polymeric film wrap or wrap sheet may be adapted to be removable from the polymeric body for a period of time, for example up to at least one year, preferably at least two years, and more preferably at least three years following application.

The inner surface of the polymeric body or outer panel substrate may be joined with or to a panel frame or panel support member, which may be a metallic support element, preferably using an adhesive.

The one or more vehicle panels (interior and/or exterior) may be formed from and/or comprise a plastic or resin material. In some configurations, the material may be selected to provide one or more desirable properties, such as resistance to heat, cold, scratching, denting, and/or abrasion, as well as dimensional stability. For example, the material may be selected such that it resists sagging, warping, shrinking, or expanding when exposed to varying temperature conditions, and may exhibit resistance to fading or degradation when exposed to sunlight (e.g., ultraviolet (UV) stability). The material may also be selected to be compatible with one or more manufacturing processes, such as injection molding, thermoforming, vacuum forming, compression molding, extrusion, machining, cutting, additive manufacturing (e.g., 3D printing), and/or combinations thereof. In some configurations, the material may further provide desired surface characteristics, such as adhesion compatibility with wrap sheets, surface energy suitable for bonding, and/or a surface finish conducive to aesthetic applications.

By way of example, the panel may comprise a thermoplastic material such as polypropylene (PP).

In other configurations, the panel may comprise other thermoplastics, such as polyethylene (PE), acrylonitrile butadiene styrene (ABS), polycarbonate (PC), polyamide (nylon), polyvinyl chloride (PVC), thermoplastic olefin (TPO), thermoplastic elastomer (TPE), or blends and copolymers thereof. In still further configurations, thermoset materials, composite materials, and/or fiber-reinforced materials may be used. The material may be unfilled or filled. For example, the material may include fillers such as glass fibers, talc, mineral fillers, ash, carbon fibers, and/or other additives to enhance strength, stiffness, impact resistance, or thermal stability. In one example, the material may comprise polypropylene filled with about 20% to about 30% glass fibers. The reinforcing fibers may be provided as short fibers, long fibers, and/or continuous fibers, depending on the desired mechanical properties.

The vehicle panel or the outer panel substrate may have a wall thickness. The wall thickness may be selected to provide one or more desired properties, such as resistance to heat, cold, scratching, denting, and/or abrasion, as well as dimensional stability. For example, the wall thickness may be configured to resist sagging, warping, shrinking, or expanding when exposed to varying temperature conditions. The wall thickness may also be selected to be compatible with one or more manufacturing processes, such as injection molding, thermoforming, vacuum forming, compression molding, machining, cutting, additive manufacturing (e.g., 3D printing), and/or combinations thereof.

The wall thickness may be substantially uniform across the outer panel substrate or may vary across different regions of the outer panel substrate. In some configurations, localized regions may have increased or decreased thickness to provide reinforcement, weight reduction, or integration with features such as the wrap edge receiving channel.

In some examples, the wall thickness may be about 1 mm or greater, about 2 mm or greater, about 3 mm or greater, about 4 mm or greater, about 5 mm or greater, about 6 mm or greater, or about 10 mm or greater. In some examples, the wall thickness may be about 20 mm or less, about 15 mm or less, about 10 mm or less, about 6 mm or less, about 5 mm or less, about 4 mm or less, about 3 mm or less, about 2 mm or less, or about 1 mm or less. The wall thickness may be within any range defined by the foregoing values.

The outer panel substrate may have any suitable color. For example, the outer panel substrate may be black, white, natural, transparent, translucent, or a combination thereof. In some configurations, one or more colorants, pigments, dyes, or additives may be incorporated into the material before or during manufacturing of the panel to produce a colored panel. In other configurations, the outer panel substrate may be coated, painted, printed, or otherwise finished after manufacturing to achieve a desired color, appearance, and/or surface effect. Such post-processing may include application of one or more layers, such as primers, base coats, clear coats, or protective coatings. For example, the colorant or pigment may be a titanium dioxide, carbon black, grey, white, or a combination thereof.

In other configurations, the outer panel substrate may be free of any coating, paints, or other surface finishes.

The material of the outer panel substrate (interior panel and/or exterior panel) may be configured to promote adhesion of one or more wrap sheets. The outer panel substrate may include one or more surface finishes and/or surface treatments that enable the wrap sheets to be supported and bonded to the surface. For example, the surface may be configured to provide suitable surface energy, texture, and/or chemical compatibility to facilitate bonding of an adhesive associated with the wrap sheets.

In some configurations, a surface treatment may be applied onto an outer surface of a panel to promote adhesion of one or more wrap sheets. For example, an adhesion promoter such as a Eastman™ CP 349W Water-Reducible Chlorinated Polyolefin Adhesion Promoter may be used. The adhesion promoter may comprise a chlorinated polyolefin which may contain 2-amino-2-methyl-1-propanol as the neutralizing amine.

In some configurations, no surface treatments may be required. Instead, the wrap or wrap sheet may be applied directly to the outer surface of the panel.

The bond between the wrap sheet and the outer panel substrate may be achieved through one or more mechanisms, including chemical bonding, mechanical interlocking, and/or intermolecular interactions such as van der Waals forces or hydrogen bonding. The bond strength may be selected to be sufficient to resist or prevent unintended peeling, lifting, or separation of the wrap sheet from the outer panel substrate under typical operating conditions, including exposure to environmental factors such as temperature variations, moisture, and mechanical stresses.

The wrap or wrap sheet may be subsequently removed from the outer panel substrate with or without an adhesive residue being left on the outer panel substrate if a user wishes to remove the wrap or wrap sheet from the outer panel substrate. The one or more surface finishes may enable an adhesive of the one or more wraps or wrap sheets to be removed from the surface of the outer panel substrate. The surface finish may include a machined finish, a smooth finish, a roughed or textured finish, a chrome finish, a painted finish, a non-painted or coated finish, a coated finish, a surface that has been subjected to a treatment to alter its surface microstructure relative to the microstructure deeper into the vehicle panel (e.g., a mechanical, chemical and/or thermal treatment), or any combination thereof. The surface finish may include a glossy or matte finished protective clear coat, powder-coated paint, low surface energy plastics and fiberglass, or a combination thereof.

The wrap or wrap sheet may include a metallic or printable surface finish. The wrap or wrap sheet may include a transparent or translucent top coat, the top coat including a functionality selected from (meth)acrylate, polyurethane and/or vinyl. The wrap or wrap sheet may be transparent or translucent. The wrap or wrap sheet may be resistant to solvents.

By way of example, it is possible that the surface to which the wrap or wrap sheet is to be applied is subjected to a treatment for altering a surface energy characteristic as compared with a pre-treatment surface energy characteristic; for example, to increase the surface energy for improving bonding.

In some embodiments, the wrap or wrap sheet may stick or adhere to the outer panel substrate with or without use of an adhesive promoter, and/or primer

The one or more wraps or wrap sheets may comprise or consist of a polymeric layer (e.g., in a film form, such as a cast film form) and an adhesive layer. The polymeric layer may have an outer facing surface (i.e., an A-surface, facing away from the outer panel substrate upon installation), that is decorative. The polymeric layer may have an inner facing surface (i.e., a B-surface, facing toward the outer panel substrate upon installation) that is coated with an adhesive or adhesive layer. One of the layers may be a tie coat layer.

The one or more wraps or wrap sheets may be provided in a layer form, such as in the form of one or more decals, stickers, overlays, patterns, labels, films, foils, or a combination thereof. The layer form may have a generally constant thickness. The layer form may comprise one or a plurality of polymeric layers (e.g., it may comprise a laminate of two or more layers or films). The one or more wraps or wrap sheets may function to elevate the appearance of the one or more vehicle panels, the vehicle, or both. The one or more wraps or wrap sheets may allow a user or owner to customize the look of their vehicle, rather than rely on standard product offerings from a vehicle manufacturer. As can be seen from the above, the one or more wraps or wrap sheets may be provided as a continuous solid-state form. The one or more wraps or wrap sheets may be provided in a form other than by spraying.

The wrap or wrap sheet may include a clear coat outer layer. For example, there may be a clear coat outer layer that includes a polyurethane. The wrap or wrap sheet may also include an image imparted to it in accordance with the teachings of US2013/0237130A1, incorporated by reference in its entirety. The image may be formed by a mask applied over a layer (e.g., over a clear coat or other outer layer), followed by abrasion of the unmasked material, and removal of the mask to reveal a matte finish and an unabraded region.

One or more of the layers may be disclosed in U.S. Pat. No. 10,301,512, the entirety of which is incorporated by reference.

The wrap or wrap sheet may have a structure that is flexible and resilient, and as such will not plastically deform during ordinary installation steps. The wrap or wrap sheet may have a structure that is not capable of supporting its own weight (i.e., when held at one of its longitudinal ends, it will sag due to gravity). The wrap or wrap sheet may have a structure that is capable of supporting its own weight (i.e., when held at one of its ends transverse to its longitudinal axis, it will not sag due to gravity).

The one or more wraps or wrap sheets may be made of one or more polymeric materials. The one or more polymeric materials may be derived from the polymerization of monomers containing a vinyl group (H2C═CH—). The one or more polymeric materials may be derived from an olefin, e.g., an α-olefin. The one or more polymeric materials may be halogenated, free of halogenation. The one or more polymeric materials may be a urethane derived material (e.g., a material derived from a reaction of an isocyanate with a polyol). Examples of suitable materials include polyvinyl chloride, thermoplastic polyurethane (e.g., and aliphatic thermoplastic polyurethane). The one or more polymeric materials may be or may comprise an acrylic. The one or more wraps or wrap sheets may be made of one or more materials that are resistant to sunlight (UV), temperature, humidity, and/or salt-spray. The one or more wraps or wrap sheets may be made of a material that is generally scratch resistant and/or self-healing. “Self-healing” refers to the ability to return to an original appearance after being deformed, such as due to scratching or abrasion. The one or more wraps or wrap sheets may include a polymeric layer configured with micro-channels, perforations, and/or a three-dimensional microstructure for enabling escape of trapped air during installation (and thus avoiding bubble formation). Examples of other polymers that may be suitable for use as a layer in the wrap or wrap sheet of the present teachings include a polyester such as a polyethylene terephthalate, a polyimide, and/or a polycarbonate; and the like.

As noted above, the one or more wraps or wrap sheets may have an A-surface that carries a decorative element. The A-surface may face outwardly or away from the outer panel substrate, and may display one or more pictures, images, patterns, designs, colors, logos, fonts, letters, numbers, marketing materials, political signs, or a combination thereof.

The one or more wraps or wrap sheets may be over-laminated or clear coated with a UV screen print clear layer over or on top of the A-surface.

The one or more wraps or wrap sheets may have a B-surface. The B-surface may face towards the outer panel substrate. The B-surface may be in contact with the outer panel substrate, e.g., indirectly through the adhesive. Additionally, or alternatively, the B-surface may be in contact with a previously applied wrap or wrap sheet.

The B-surface may comprise one or more adhesives to attach or connect the one or more wraps or wrap sheets to the outer panel substrate. The adhesive may be a high-tack adhesive that is configured for adhesion to glossy and matte finished protective clear coats, powder-coated paints, low surface energy plastics and fiberglass, or a combination thereof. The adhesive may include a pressure-sensitive adhesive and/or a high-tack adhesive.

The adhesive or adhesive layer may be covered or protected by one or more release layers, such as one or more carriers, foils, or backings that must be removed to expose the adhesive. A release layer may be a low friction or energy material that is easily removed or separatable from the adhesive or back side of the polymeric layer to expose the adhesive layer. The release layer may be of the type disclosed in US 2018/0079187A1 (e.g., paragraphs [0086-0092]), incorporated by reference in its entirety.

Additionally, or alternatively, an adhesive may be applied to the back side of the wrap or wrap sheets and/or the outer panel substrate. Such an adhesive may be applied as a paste, liquid, spray, or a combination thereof. The adhesive may include a pressure sensitive adhesive. The adhesive may include one or more acrylic compounds.

The adhesive or adhesive layer may include one or more ingredients such as a light stabilizer (e.g., a hindered amine light stabilizer such as a NOR-HALS stabilizer). An example of a suitable UV additive may be found in US 2015/0086782 A1, incorporated by reference in its entirety, see e.g., paragraphs [0053-0077] and paragraph [0103]. Other additives may be in the adhesive layer such as an antioxidant, a tackifier, a softener, a filler, a colorant, a flame retardant or otherwise.

Other adhesive systems may be employed including but not limited to adhesives based upon vinyl acetate, rubbers, and/or silicones, see also US 2018/0079187A1 (e.g., paragraphs [0077-0085]), incorporated by reference in its entirety.

Examples of acrylic based adhesive systems useful in accordance with the present teachings are found in U.S. Pat. No. 10,550,297 B2 (e.g., columns 4-5) incorporated by reference in its entirety.

The wrap or wrap sheet may include a clear coat outer layer. For example, there may be a clear coat outer layer that includes a polyurethane.

The wrap or wrap sheet may be free of any mechanical fasteners for attaching the wrap or wrap sheet to the outer panel substrate. Such mechanical fasteners may include clips, pins, screws, rivets, or a combination thereof.

The polymeric material layer of the wrap or wrap sheet may be capable of functioning without degradation visible to the naked eye, under midday sunlight, from a distance of two meters of over a temperature range of −50 to 85 °C.

The adhesive layer of the wrap or wrap sheet may be capable of exhibiting a peel strength to the surface of the outer panel substrate, of at least 600 N/m, and preferably at least 650 M/m, and more preferably at least 700 or 750 N/m. The wrap or wrap sheet may withstand a 90 Degree peel adhesion test in accordance with testing standard ASTM D6862-11.

The polymeric material of the wrap or wrap sheet may be capable of exhibiting a flexural modulus of at least 45 MPa), and more preferably at least 55 MPa per ASTM D790-17. The polymeric material of the wrap or wrap sheet may be capable of exhibiting a flexural modulus of no more than 150 MPa, and more preferably no more than 110 MPa per ASTM D790-17. The polymeric material of the wrap or wrap sheet may be capable of exhibiting an ultimate tensile strength of at least 50 MPa, and more preferably at least 60 MPa per ASTM D882-18. The polymeric material of the wrap or wrap sheet may be capable of exhibiting an ultimate tensile strength of no more than 150 MPa, and no more than 100 MPa per ASTM D882-18. The polymeric material of the wrap or wrap sheet may be capable of exhibiting an elongation at break of at least 250%, more preferably at least 300% and still more preferably at least 350%, per ASTM D882-18. Unless otherwise stated in a specified standard, all testing herein assumes testing at room temperature (23 °C).

One or more different effects may be imparted to the wrap or wrap sheet including but not limited to the formation of a diffraction grating over at least a portion of the polymeric material layer (e.g., as a coating and/or sub-layer), as described in US 2022/0227315, incorporated by reference in its entirety for all purposes. The film may otherwise be processed to include a texture on or within a layer, such as is described in WO/2019/169079 A1, incorporated by reference in its entirety.

Decorative elements can be formed in and/or on the polymeric film layer, the adhesive layer or both. For example, the adhesive layer may have an image that can be seen through a transparent or translucent polymeric film layer. Examples of techniques suitable for forming decorative elements are illustrated in U.S. Pat. No. 10,981,371 B2, incorporated by reference in entirety for all purposes.

For all of the teachings herein, unless described as being limited to a monolayer, may include a plurality of sublayers (e.g., a laminate of a plurality of films).

In one example, the wrap or wrap sheet may comprise one or more elements, features, or characteristics of the Avery Dennison® MPI 1106 Hi-Tack Easy Apply premium cast film, Avery Dennison® MPI 1105 Wrapping Film, Avery Dennison® MPI 1060 Transparent film. The wrap or wrap sheet may comprise a digitally printable film, Avery Dennison® SW900 Series.

The wrap or wrap sheet may withstand rock chip testing in accordance with SAE J400. The wrap or wrap sheet may be capable of withstanding impact from particles, such as airborne debris, stones, sand particles, etc., which may hit the film surface at high speeds. To evaluate the impact resistance, the wrap or wrap sheet is evaluated using an ASTM D968-93 testing method. The wrap or wrap sheet may resist degradation, stone chipping, peeling, UV fading, salt spray degradation, scratching, or other failure for a period of at least 1 year, preferably at least 2 years, more preferably at least 5 years. The wrap or wrap sheet may have an outer surface that resists scratching or destruction due to damage when the vehicle panel comes into contact with a rough surface.

The outer exposed surface of the wrap or wrap sheet may have a hydrophobic topcoat, a high gloss finish with no orange peel finish, or a matte finish.

The wrap or wrap sheet may comprise a thickness on the order of about 1 mm to about 7 mm. in some instances the wrap or wrap sheet may have a thickness of about 3 mm.

This thickness may be inclusive of only the A-surface, or both of the A-surface and the adhesive.

In other configurations, the adhesive can be a spray or paste that is applied to the wrap or wrap sheet, the outer panel substrate, or both, before attaching the wrap or wrap sheet to the outer panel substrate.

The wrap or wrap sheet may be configured as a single-use application. This means that after the wrap or wrap sheet is applied to the outer panel substrate, it cannot be removed without damaging the wrap or wrap sheet. In other configurations, the wrap or wrap sheet may be configured as a multi-use application. This means that the wrap or wrap sheet can be installed on the outer panel substrate, removed, and then re-applied onto the outer panel substrate. A single-use application may allow for the wrap or wrap sheet to better adhere to the outer panel substrate. A multi-use application may allow for a user to reposition the wrap or wrap sheet in case the wrap or wrap sheet is not applied correctly or straight the first time.

The vehicle panel may include one or more poka-yoke features. A poka-yoke feature may help a user align and/or orient the one or more wraps or wrap sheets in a proper orientation or location on the outer panel substrate during installation or application. For example, the one or more poka-yoke feature may include one or more channels, projections, lines or scribe marks, apertures, ribs, or a combination thereof.

One or more of the vehicle panels (interior or exterior) may include one or more wrap edge receiving channels. One or more panels of the vehicle may be free of or not include any wrap edge receiving channels.

A wrap edge receiving channel may be a channel, trench, trough, canal, gouge, indentation, gutter, recess, depression, slot, or similar feature that is formed into a surface or thickness of the outer panel substrate of the vehicle panel. The channel may be formed into a surface or thickness of the vehicle panel such that the channel is integral with the panel. The wrap edge receiving channel may be configured to receive, position, and/or retain one or more edges of one or more wrap sheets.

In some configurations, the wrap edge receiving channel may be formed directly in the outer panel substrate such that the channel is integral with the vehicle panel. In other configurations, the wrap edge receiving channel may be formed by a separate component attached to or integrated with the outer panel substrate.

A wrap edge receiving channel may extend at least partially or entirely along a length or width of a panel. A wrap edge receiving channel may have a length that extends continuously along a length of width of a panel. A wrap edge receiving channel may have a length that is interrupted along a length of width of a panel. In other words, a wrap edge receiving channel may start and stop along a length of width of a panel. A wrap edge receiving channel may have a length that extends substantially across an entire length of the vehicle, for example from a location that is forward of or at the front wheels to a location that is rearward of or at the rear wheels. The wrap edge receiving channel may extend along a horizontal plane that intersects the vehicle at the front headlight assemblies. The wrap edge receiving channel may extend along an entire length or width of a panel with no gaps or spaces between the outer most edges of the panel and the beginning of the wrap edge receiving channel. The wrap edge receiving channel may extend at or along a top edge or region of a door handle.

A wrap edge receiving channel may separate or divide a panel into two or more adjacent panel portions, such as a first panel portion and a second panel portion. Depending on the orientation of the panel and/or the wrap edge receiving channel in vehicle position, the first panel portion and the second panel portion may also or may instead be referred to as an upper panel portion and a lower panel portion, a left panel portion and a right panel portion, a forward panel portion and a rearward panel portion, etc., or any combination thereof.

A wrap edge receiving channel may be located at an upper region of a panel, a lower region of a panel, or in a central region of a panel. An upper region may be defined as a top ⅓ of the overall panel height or width below an upper most edge of the panel, a central region may be defined within a middle ⅓ of the overall height or width of a panel, and a lower region may be defined as or within a bottom ⅓ of the overall height or width of a panel below the lower most edge of the panel.

A wrap edge receiving channel may be defined by one or more surfaces or walls. For example, a wrap edge receiving channel may be defined by a first surface or wall, a second surface or wall, and a connecting surface or wall extending therebetween. Depending on the orientation of the channel in vehicle position, the first wall and the second wall may also or may instead be referred to herein as an upper surface or wall and a lower surface or wall, a left surface or wall and a right surface or wall, a forward surface or wall and a surface or rearward wall, etc., or any combination thereof.

The walls or surfaces of the wrap edge receiving channel including the connecting surface or wall may be substantially planar, curved, sloped, angled, horizontal, vertical, or a combination thereof. The surfaces or walls of the wrap edge receiving channel including the connecting wall may have a wall component or region that is planar, curved, sloped, angled, horizontal, vertical, drafted, or a combination thereof.

The material thickness of the channel and the region of the panel surrounding the channel may be substantially uniform or constant. This means that the wrap edge receiving channel is not a thinned out region of the panel that may reduce the structural integrity of the panel. Instead, the channel may be molded or formed directly into the panel.

In other configurations, the wrap edge receiving channel may be a thinned out region of the panel relative to other portions of the panel.

A wrap edge receiving channel may function to and/or may be dimensioned and configured to receive an edge or terminal edge of one or more wraps or wrap sheets. A wrap edge receiving channel may function to and/or may be dimensioned and configured to conceal an edge or terminal edge of one or more wraps or wrap sheets from view, when an observer is positioned inside the vehicle or outside of the vehicle. A wrap edge receiving channel may function to and/or may be dimensioned and configured to conceal or block an edge of one or more wraps or wrap sheets from outdoor conditions, such as sunlight, rain, car wash, salt spray, the like or a combination thereof. In some configurations, a wrap edge receiving channel may be an ornamental feature in the one or more vehicle panels that provides an ornamental or aesthetic appearance to the body panel. The wrap edge receiving channel may function to break up the entire surface of a body panel so that smaller sheets of wrap or wrap sheets can be used to cover the body panel. This may advantageously make it easier to handle a wrap or wrap sheet during application, as opposed to handling a very large wrap or wrap sheet to cover an entire body panel.

The following description illustrates the teachings herein.

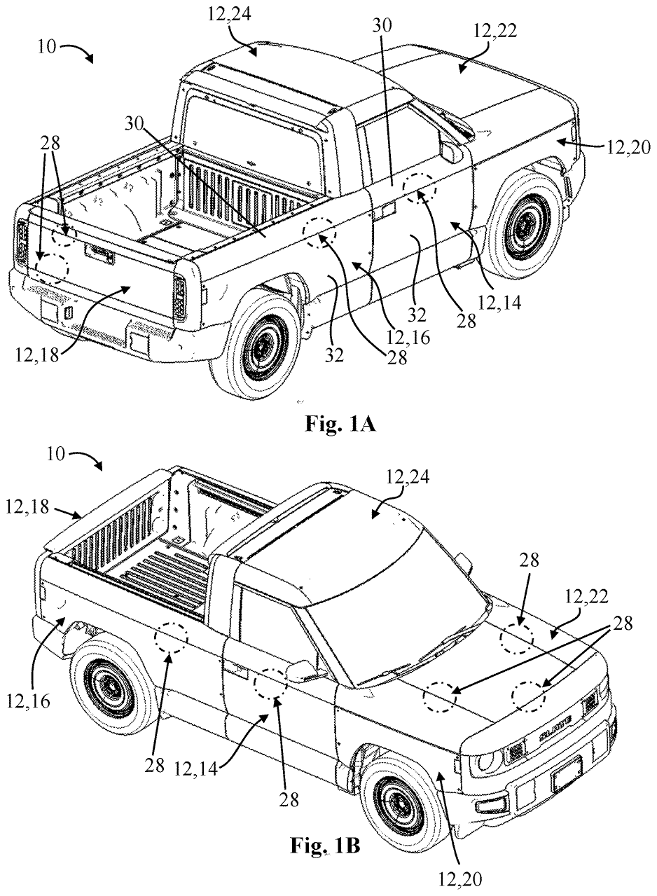

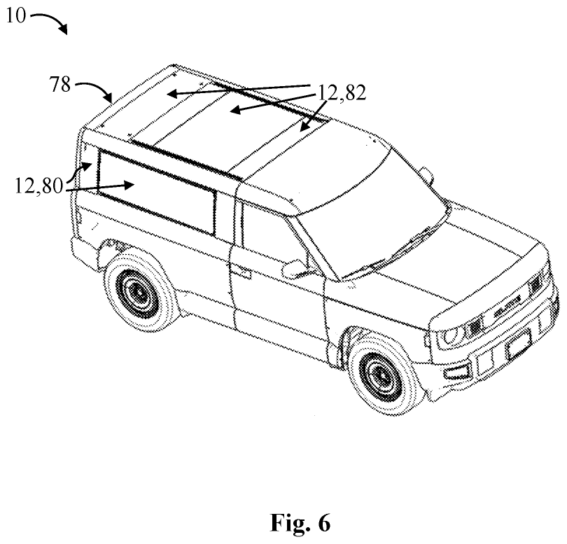

FIGS. 1A and 1B illustrate a vehicle 10. The vehicle 10 comprises a body having one or more vehicle body panels 12. The one or more panels 12 may include a door panel 14, a rear fender 16, a tailgate 18, a front fender 20, a hood 22, and a roof 24. Unless otherwise expressly specifically noted, a general reference to a panel herein may refer to one or more of any vehicle body panel, interior and/or exterior vehicle body panel). With additional reference to FIG. 6, the vehicle 10 comprises a rear enclosure assembly 78. The rear enclosure assembly may be part of an SUV kit for use when transforming or reconfiguring the vehicle 10 from the pickup truck configuration and the sport utility (SUV configuration). The SUV enclosure 78 may comprise one or more vehicle body panels 12, including one or more side panels 80 and one or more roof panels 82, one or more of which may include one or more wrap edge receiving channels 28.

The vehicle 10 may be reconfigurable between a pickup truck configuration and a sport utility (SUV) configuration (FIG. 6). The vehicle 10 may have a frame comprising a front region that is located generally over a pair of front wheels of the vehicle and a rear region that is located generally over a pair of rear wheels of the vehicle, rear region having a pair of opposing bed walls and a rear floor, wherein frame comprises one or more frame fastening devices; a rear enclosure assembly configured to attach to the one or more preexisting fasteners on the frame to reconfigure the vehicle from the pickup truck configuration to the SUV configuration, the rear enclosure assembly comprising: i) a roll bar assembly comprising a hoop structure having a pair of spaced apart pillars, an upper cross bar connected to upper regions of the pillars, and optionally a lower cross bar; and ii) one or more rear passenger seats configured for attachment to the roll bar assembly; wherein the hoop structure is attached to the opposing bed walls and/or the rear floor of the frame. Further details of the vehicle, the various configurations, and/or the frame are illustrated in U.S. 63/785,542 filed on Apr. 8, 2025, U.S. 63/788,545 filed on Apr. 14, 2025, and/or U.S. 63/792,518 filed on Apr. 22, 2025, the entireties of which are all hereby incorporated by reference herein for all purposes

Further aspects of the vehicle 10, the one or more configurations or states 13,15, the rear enclosure assembly 61, and elements thereof are disclosed in U.S. patent application Ser. No. 19/642,294 filed on Apr. 8, 2026, the entirety of which is incorporated herein by reference.

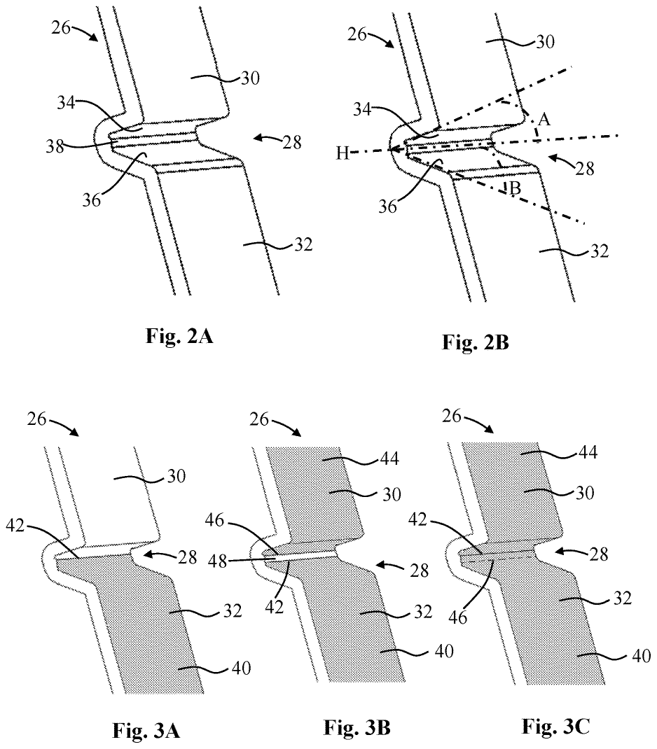

With additional reference to FIGS. 2A-2B, a vehicle panel 12 may include an outer panel substrate 26. The outer panel substrate 26 may be a polymeric body. The outer panel substrate 26 and/or polymeric body that may be supported on, or affixed to, an inner frame or substrate. The inner frame or substrate may be a support element configured to provide strength and rigidity to the outer panel substrate 26 or polymeric body. The inner frame or substrate or support element may comprise a metal material, a polymeric material, or both.

The inner frame or substrate The outer panel substrate 26 may be the part of the vehicle panel 12 that faces an exterior or environment surrounding the vehicle. In the case of an interior panel substrate 26 positioned inside the vehicle, the outer panel substrate 26 may be the part of the vehicle panel 12 that faces the interior or cock pit of the vehicle and is visible and/or accessible to a passenger of the vehicle located inside the vehicle.

One or more portions of the outer panel substrates 26 may be made of a plastic or polymeric material. For example, the outer panel substrate 26 may comprise a polypropene material.

The outer panel substrate 26 may comprise one or more wrap edge receiving channels 28. A wrap edge receiving channel 28 may extend at least partially, or entirely, along a length or along a width of a panel substrate 26. The wrap edge receiving channel 28 may separate the panel substrate 26 into a first panel portion 30 on one side of the channel 28 and a second panel portion 32 on another side of the channel 28. The first panel portion 30 and the second panel portion 32 may be integral parts or portions of the structure of the panel 12. In other words, the first panel portion 30 and the second panel portion 32 may not be separate or individual parts or pieces of the panel 12.

However, it is envisioned that in some configurations, a vehicle panel 12 may be constructed of two or more separate portions (e.g. first panel portion 30 and second panel portion 32) that are then joined together via one or more wrap edge receiving channels 28. In such a configuration, the adjoining edges, or walls, or surfaces of the portions 30, 32 may be located within a wrap edge receiving channel 28 and define therein the walls or surface of a wrap edge receiving channel.

The outer panel substrate 26 and/or one or more portions of a panel substrate 26 may be configured to be at least partially covered by one or more wrap sheets. The wrap edge receiving channel 28 may comprise a channel into which one or more edges or terminal edges or portions of one or more wrap sheets are received.

A wrap edge receiving channel 28 may be defined by a first surface or wall 34, a second surface or wall 36, and a connecting surface or wall 38 extending therebetween.

In some instances, the first wall 34, the second wall 36, and/or the connecting wall 38 may each be defined by a plurality of sub-surfaces or sub-walls. For example, one or more of the walls 34, 36, 38 may include two or more adjoining surface or wall segments (e.g., angled, stepped, curved, or faceted portions) that collectively define the corresponding wall 34, 36, 38 of the channel 28. Accordingly, one or more of the walls 34, 36, 38 may have a multi-surface configuration rather than a single continuous surface.

The first surface or wall 34 may be connected to or integral with the first panel portion 30, and the second surface or wall 36 may be connected to or integral with the second panel portion 32.

When the panel 12 and/or the wrap edge receiving channel 28 is viewed in cross section, the channel may have a C-shape, a V-shape, or a U-shape.

The channel 28 may have a substantially concave structure or geometry.

When the panel 12 and/or the wrap edge receiving channel 28 is viewed in cross section, the walls 34, 36, 38 may have a substantially constant or uniform wall thickness.

When the panel 12 and/or the wrap edge receiving channel 28 is viewed in cross section, a thickness of the panel 12 is substantially constant or the same in a region above and/or below the wrap edge receiving channel 28. More specifically, the first panel portion 30, the walls 34, 36, 38, of the wrap edge receiving channel 28, and the second panel portion 32 may have a substantially constant, uniform, or the same wall thickness.

An angle A of the first wall 34 relative to a center or horizontal plane H may be approximately 0 degrees or more, 5 degrees or more, 10 degrees or more, 20 degrees or more, 30 degrees or more, 40 degrees or more, 45 degrees or more. An angle A of the first wall 34 relative to a horizontal plane H may be approximately 60 degrees or less, 45 degrees or less, 30 degrees or less, 20 degrees or less, 15 degrees or less, 10 degrees or less, 5 degrees, or less. Preferably, the angle A of the first wall 34 relative to a horizontal plane H may be about 20 degrees or more or less than about 30 degrees.

An angle B of the second wall 36 relative to a horizontal plane may be approximately 0 degrees or more, 5 degrees or more, 10 degrees or more, 20 degrees or more, 30 degrees or more, 40 degrees or more, 45 degrees or more. An angle B of the second wall 36 relative to a horizontal plane may be approximately 60 degrees or less, 45 degrees or less, 30 degrees or less, 20 degrees or less, 15 degrees or less, 10 degrees or less, 5 degrees, or less. Preferably, the angle B of the second wall 36 relative to a horizontal plane may be about 20 degrees or more or less than about 30 degrees.

The connecting wall 38 may be substantially planar, angled, sloped, or curved. The connecting wall 38 may be orthogonal to the first and/or second wall. The connecting wall 38 may have a concave structure.

A slope of the first wall 34 may be less than a slope of the second wall 36, as measured or observed relative to a horizontal plane extending through the channel 28.

In other configurations, a slope of the first wall 34 may be greater than or the same as a slope of the second wall 36, as measured or observed relative to a horizontal plane extending through the channel 28.

Referring now to FIGS. 3A-3C, one or more of the vehicle panels 12 or panel portions may be covered by one or more or more wrap sheets.

A wrap sheet 40 may have one or more edges. An edge may be a terminal edge, region, portion, area, or boundary that defines a size and/or shape of a wrap sheet 40. Depending on the size and shape of the wrap sheet, a wrap sheet may have a plurality of edges. A wrap sheet may be applied onto the outer panel substrate 26 of a panel 12 so that one or more edges of a wrap sheet 40 is/are received into one or more wrap edge receiving channels 28. The wrap sheet 40 may include an A-side and an opposing B-side. After the wrap sheet 40 is attached to and/or supported on the outer panel substrate 26 of the panel 12, the A-side may be visible or laterally facing outward. The opposing B-side may include an adhesive that may be used to attach or secure the wrap sheet 40 to the outer panel substrate 26 of the panel 12.

A tool may be used to press, push, or wet out the wrap sheet 40 against the panel substrate 26. The tool may be used to press, push, or wet out the edge of the wrap sheet 40 into the wrap edge receiving channel 28 so that the adhesive on the wrap sheet 40 bonds to the panel substrate 26.

In some instances, the tool may be configured to cut the wrap before, during, or after the wrap or wrap sheet is applied to the panel or into the receiving channel 28.

For example, with specific reference to FIG. 3A a wrap sheet 40 may be a lower wrap sheet 40 that is applied onto the second panel portion 32 of the panel substrate 26. An upper edge 42 of the lower wrap sheet 40 is received into the wrap edge receiving channel 28. The upper edge 42 of the lower wrap sheet 40 may be located in or may cover the lower wall 36, the connecting wall 38, and/or the upper wall 34. The first wall 34 may function as a roof or ledge that covers the upper edge 42 from view and/or exposure to the elements (sun, rain, salt spray, car wash, etc.). Accordingly, when the panel 12 is viewed by an observer, upper edge 42 of the lower wrap sheet 40 is not in the observer's line of sight due to the edge 42 being received into the channel 28 and blocked by the structure of the channel 28 (e.g., the extending walls 34, 36, 38) thereby providing an aesthetically pleasing appearance. Moreover, the edge 42 is not directly exposed to the surrounding environment (e.g., sun rain, car wash environment), which may prevent the edge 42 from separating from the panel 12.

Furthermore, the first panel portion 30 and the second panel portion 32 may be configured relative to the channel 28 to define a water-shedding feature. In particular, one or more surfaces of the first panel portion 30 may be oriented, contoured, angled, and/or positioned such that rain, water, salt spray, and the like are directed to travel downwardly from the first panel portion 30 to the second panel portion 32 along a flow path that bypasses the channel 28. The channel 28 may be recessed, offset, and/or shielded relative to the flow path such that fluid is inhibited from entering the channel 28. Accordingly, the edge(s) of the wrap sheet(s) positioned within the channel 28 are protected from exposure to the rain, water, salt spray, and the like, and are less prone to lifting or separating from the outer panel substrate 26.

The water-shedding feature may be configured to direct fluid along a gravity-driven flow path that bypasses the channel 28, thereby reducing fluid accumulation within the channel 28 and inhibiting ingress into the channel 28. In some configurations, the first panel portion 30 may be positioned further outboard relative to the second panel portion 32 such that fluid traveling along the first panel portion 30 is directed away from the channel 28.

Referring now to FIG. 3B, an upper wrap sheet 44 may be applied onto the outer panel substrate 26. The upper wrap sheet 44 may be a completely separate sheet or element from the lower wrap sheet 40. The upper wrap sheet 44 may be applied onto the first panel portion 30 of the panel substrate 26. A lower edge 46 of the upper wrap sheet 44 is received into the wrap edge receiving channel 28. The lower edge 46 of the upper wrap sheet 44 may be located in or may cover the lower wall 36, the connecting wall 38, and/or the upper wall 34. The edges 42, 46 may be spaced apart within the channel 28 such that a gap 48 is defined therebetween. The gap 48 may be an exposed portion of the substrate 26 and/or channel 28 where no wrap sheet is located. With both edges 42, 46 located within the channel 28, when the panel 12 is viewed by an observer, the upper and lower edges 42, 46 of the wrap sheets 40, 44 is/are not in the observer's line of site due to the edges 42, 46 being blocked by the structure of the channel 28 (e.g., the inwardly extending walls 34, 36, 38) thereby providing an aesthetically pleasing appearance. Moreover, the edges 42, 46 is/are not directly exposed to the surrounding environment (e.g., sun rain, car wash environment), which may prevent the edges 42, 46 from separating from the panel 12.

With reference now to FIG. 3C, when a panel 12 or outer panel substrate 26 is covered by both a lower wrap sheet 40 and an upper wrap sheet 44, one edge 42, 46 may overlap another edge 46, 42 within the channel 28. For example, the lower edge 46 of the upper wrap sheet 44 may overlap the upper edge 42 of the lower wrap sheet 40, or vice versa (e.g. the upper edge 42 of the lower wrap sheet 40 may overlap the lower edge 46 of the upper wrap sheet 44). The overlap region of the wrap sheets 40, 44 may be located in or over the upper wall 34, the lower wall 36 and/or the connecting wall 38 of the channel 28.

In another embodiment, the terminal edges 42, 46 of the wrap sheets 40, 44 may be positioned to abut one another within the channel 28 such that the edges are in direct contact without overlapping. In this configuration, the terminal edges 42, 46 may be aligned along one or more of the upper wall 34, the lower wall 36, and/or the connecting wall 38 of the channel 28 to define a substantially continuous interface between the wrap sheets 40, 44. The abutting arrangement may be configured to minimize or eliminate any gap between the terminal edges 42, 46, thereby reducing the likelihood of fluid ingress, debris accumulation, or edge lifting within the channel 28. In some implementations, the terminal edges 42, 46 may be trimmed, contoured, or otherwise formed to complement one another to facilitate a tight interface along the abutting joint.

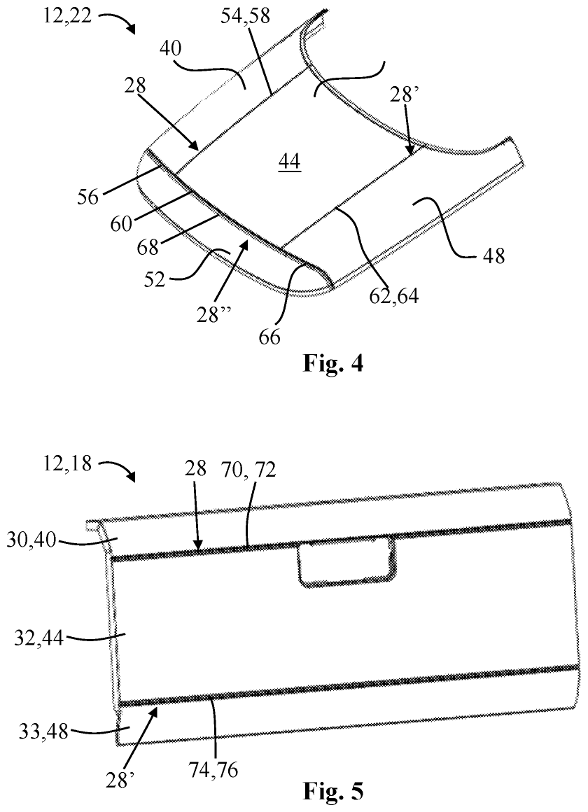

Referring to FIG. 4, a vehicle panel 12 is illustrated. The panel 12 may be a vehicle hood 22. However, the following may refer to any vehicle panel disclsoed herein. The hood panel 22 may comprise an outer panel substrate 26 having more than one wrap edge receiving channel. Specifically, the panel 12 may comprise more than two (2) wrap edge receiving channels, and even more specifically three (3) wrap edge receiving channels, namely a first wrap edge receiving channel 28, a second wrap edge receiving channel 28′, and a third wrap edge receiving channel 28″. The receiving channels 28, 28′, 28″ may have a structure and configuration that is substantially similar to the channel 28 described herein and/or illustrated and described at FIGS. 2A-3C.

Two of the wrap edge receiving channels 28 and 28′ may be arranged transverse to the other wrap edge receiving channel 28″.

More than two wrap sheets may be attached or adhered to the outer panel substrate 26 of the hood panel 22. An edge of each wrap sheet may be received into a channel 28. For example, in this illustrated example, four separate and discreate wrap sheets 40, 44, 48, 52 may cover the hood panel 22.

A first wrap sheet 40 may have an edge 54 that is received into a channel 28 and another edge 56 that is received into the transverse channel 28″.

A second wrap sheet 44 may have an edge 58 that is received into channel 28, a second edge 60 that is received into the transverse channel 28″, and a third edge 62 that is received into channel 28′.

A third wrap sheet 48 may have an edge 64 that is received into channel 28′ and another edge 66 that is received into the transverse channel 28″.

A fourth wrap sheet 52 may have an edge 68 that is received into the transverse channel 28″. The transverse channel 28″ may therefore receive 4 or more edges of discrete wrap sheets in this vehicle panel 12 or hood 22 embodiment.

Even though the panel 12 is covered or wrapped by discrete wrap sheets, because the edges of the discrete wrap sheets are placed into the wrap edge receiving channels 28, the edges are not visible to an ordinary observer. Accordingly, the panel 12 will appear to be covered by a single uniform sheet. Moreover, when the panel 12 is viewed by an observer, the edges of the wrap sheets is/are not in the observer's line of site due to the edges being received into the channel and blocked by the structure of the channel (e.g., the inwardly extending walls 34, 36, 38; see FIGS. 2-3C) thereby providing an aesthetically pleasing appearance. Lastly, the edges is/are not directly exposed to the surrounding environment (e.g., sun rain, car wash environment), which may prevent one or more of the edges from separating from the panel 12.

The panel geometry, including multiple surfaces having varying radii of curvature, angles, and orientations in different planes, may be configured to make application of the wrap material easier. For example, transitions between adjacent surfaces may be gradual or defined in a way that allows the wrap material to be applied in sections without requiring excessive stretching or repositioning. Changes in surface direction may provide natural reference points for aligning and laying the wrap material. The geometry may also reduce or avoid compound curves that tend to cause wrinkling, bubbling, or air pockets. In some configurations, the panel geometry works together with the wrap edge receiving channels to relieve stress in the wrap material by allowing edge portions or excess material to be received in the channels. As a result, an ordinary user can apply the wrap material more easily and with fewer defects, such as folds, bubbles, or lifting.

FIG. 5 illustrates a vehicle panel 12. The panel 12 may be a vehicle tailgate 18. However, the following may refer to any vehicle panel disclsoed herein.

The tailgate 18 comprises an outer panel substrate 26 having one or more wrap edge receiving channels. Specifically, the panel 12 comprises a wrap edge receiving channel 28 and a second wrap edge receiving channel 28′. Each of the receiving channels 28, 28′ may have a structure and configuration that is substantially similar to the channel 28 illustrated and described at FIGS. 2A-3C.

The two wrap edge receiving channels 28 and 28′ may be arranged substantially parallel to one another and separate the panel 12 into three panel portions 30, 32, 33.

More than two wrap sheets may be attached or adhered to the outer panel substrate 26 of the panel 12. An edge of each wrap sheet may be received into a channel. For example, in this illustrated example, three separate and discreate wrap sheets 40, 44, 48 may cover the panel 12.

A first wrap sheet 40 may have an edge 70 that is received into channel 28. A second wrap sheet 44 may have an edge 72 that is received into channel 28 and a second edge 74 that is received into the second wrap edge receiving channel 28′. A third wrap sheet 48 may have an edge 76 that is received into channel 28′. The channel 28, 28′ may each receive 2 or more edges of discrete wrap sheets.

A combination or kit is disclosed herein. The combination or kit may comprise one or more vehicle panels 12, one or more wrap sheets, and optionally a tool for installing or removing one or more edges of a wrap sheet into or from a wrap edge receiving channel. The tool may comprise an end that is sufficiently sized to fit within a wrap edge receiving channel. The end may have a roller end or soft end to not damage the wrap sheet when a force is applied by the end onto the wrap sheet. The kit may include an instruction video, manual, or brochure for installing or applying the one or more wraps or wrap sheets to the one or more vehicle panels 12. The kit may include a cleaning solution for cleaning the one or more vehicle panels 12 before applying the one or more wraps or wrap sheets. The cleaning solution may be an alcohol, soap, or other mixture.

A method is disclosed of applying a wrap sheet onto a vehicle panel. The method may include a step of cleaning the surface of the outer panel substrate with a cleaning solution like soap, water, alcohol, etc. The cleaning step may be aimed at removing dust, mud, gunk, water, or any other contaminants from the outer panel substrate to ensure the wrap or wrap sheet adheres directly to the outer panel substrate.

The method may include a step of exposing the adhesive on the back side of the wrap sheet. This step may include removing a backing from the back side of a wrap sheet to expose the adhesive. Additionally or alternatively, the step may include applying an adhesive onto the panel substrate and/or the back side of the wrap sheet.

The method may include a step of aligning the wrap sheet with one or more poka-yokes to ensure the wrap sheet is properly aligned on the outer panel substrate. The method may include a step of aligning the wrap sheet with the wrap edge receiving channel. Aligning the wrap sheet with the wrap edge receiving channel may include placing the edge or perimeter of the wrap sheet within the wrap edge receiving channel. The edge of the wrap sheet may be placed in the wrap edge receiving channel via the hand or fingers of an owner or installer of the wrap or wrap sheet, a squeegee, or other tool.

The method may include a step of applying the wrap sheet onto the panel substrate so that one or more edges of the wrap sheet are located in a wrap sheet receiving channel. The method may include a step of wetting out the wrap sheet by applying heat and/or pressure to the surface of the wrap sheet. The heat may be applied via a hair dryer, heat gun, or the like. The method may include a step of applying pressure onto the wrap sheet to wet out the adhesive. The pressure may be applied so that the edge of the wrap sheet is received into the wrap edge receiving channel. The pressure may be applied by the hand or fingers of an owner or installer of the wrap sheet, a squeegee, or other tool. The method may include a step of removing air or water bubbles or pockets with a tool, such as a squeegee. The method may include a step of wetting out the edges of the wrap sheet within the wrap edge receiving channel.

It is understood that the method steps can be performed in virtually any order and are not necessary to be in the order disclosed herein unless otherwise noted. One or more of the steps can be combined with one or more other steps; one or more steps can be omitted or eliminated; one or more steps can be repeated or duplicated; one or more steps can be split into two or more steps; one or more of the steps can be rearranged in a different order relative to other method steps; or any combination hereof.

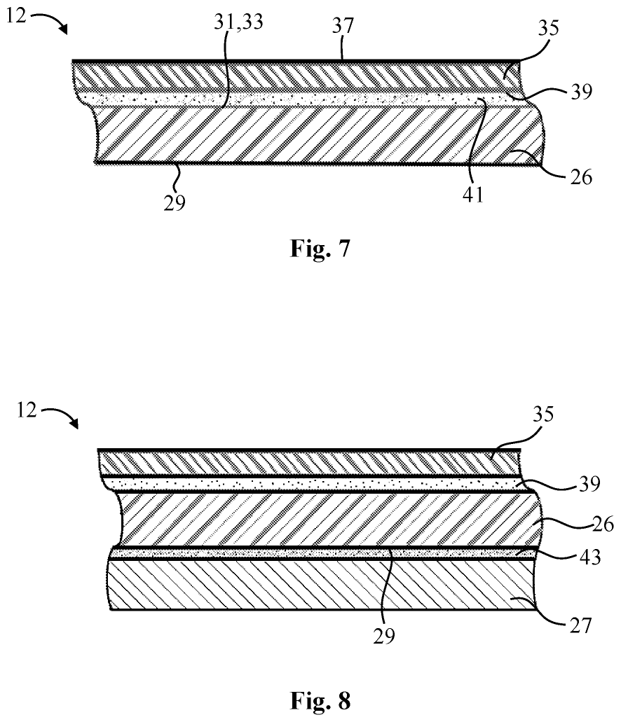

FIGS. 7 and 8 each illustrate a vehicle panel 12 in cross section. The vehicle panel 12 may include one or more wrap edge receiving channels according to these teachings.

In FIG. 7, the vehicle panel 12 may comprise an outer panel substrate or polymeric body 26 and a panel frame or panel support member 27.

The vehicle panel 12 may be a horizontally oriented panel, preferably as a hood, a decklid, a bed, and/or a roof, and/or as a vertically oriented panel, preferably as a grille, a fender, a door, a bulkhead and/or a tailgate.

The vehicle panel 12 may be an accessory or interior panel, preferably as an instrument panel, a console, a door panel, an interior trim component, and/or a headliner.

The outer panel substrate or polymeric body 26 may be a thermoplastic body, and, more preferably, may be a three dimensionally shaped polyolefin body panel. The outer panel substrate or polymeric body 26 comprises an inner surface 29 and an outer surface 31. The outer surface 31 may have a surface texture 33. The surface texture 33 may be a grained surface texture.

The surface texture 33 may comprise a microtexture formed on the substrate 26. In some configurations, the surface texture 33 includes a plurality of grains or projections distributed across the surface of the substrate 26. The grains or projections may be formed integrally with the substrate (e.g., molded-in texture) or applied in a secondary process.

The plurality of grains or projections may define a textured profile having a peak-to-valley height (or depth) of less than about 0.1 mm. In some embodiments, the grains or projections may have a height in a range of about 0.02 mm to about 0.1 mm, and more particularly about 0.03 mm to about 0.06 mm. In certain implementations, the grain height may be approximately 0.02 mm, 0.03 mm, or 0.06 mm.

The grains or projections may have a distribution of grains per uniform area that are all generally uniform.

The surface texture may have a texture that can exhibit Stipple, Sand, Woven, Powder, Pulp, or Orange Peel characteristics.

The grain or outer surface may include a draft, such as 1 degree or more 2 degrees or more, 3 degrees or more 5 degrees or less, or 4 degrees or less.

A polymeric film wrap or wrap sheet 35 may be on the polyolefin substrate 26. The wrap sheet 35 may include a film having an outer surface 37 and inner surface 39. The inner surface 39 may comprise an adhesive layer 41 that contacts the outer surface 31 of the substrate 26. The polymeric film wrap or wrap sheet 35 may be adapted to be removable from the polymeric body 26 for a period of time, for example up to at least one year, preferably at least two years, and more preferably at least three years following application.

The inner surface 29 of the polymeric body 26 may be joined with or to a panel frame or panel support member 27, which may be a metallic support element, preferably using an adhesive 43.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference in its entirety for all purposes. Other combinations are also possible as will be gleaned from the following claims, which are also hereby incorporated by reference into this written description.

1. A combination of a vehicle panel, a first wrap sheet, and a second wrap sheet for a vehicle, the vehicle being reconfigurable between a pickup truck configuration and a sport utility vehicle (SUV) configuration, the vehicle comprising a vehicle frame configured to support both the pickup truck configuration and the SUV configuration and to allow reconfiguration therebetween without permanently modifying the vehicle frame, the method comprising, the vehicle panel comprising:
an outer plastic panel substrate;
a metallic panel support member;
an adhesive bonding the outer plastic panel substrate to the support member; and
a wrap edge receiving channel extending at least partially along a width of the outer plastic panel substrate and separating the plastic panel substrate into a first panel portion on one side of the channel and a second panel portion on another side of the channel,
wherein the wrap edge receiving channel is configured to receive a first edge of the first wrap sheet and a second edge of the second wrap sheet.

2. The combination according to claim 1, wherein the first panel portion of the vehicle panel and the second panel portion of the vehicle panel are an integral structure or panel.

3. The combination according to claim 2, wherein the wrap edge receiving channel is defined by an upper wall, a lower wall, and a connecting wall extending therebetween, wherein a slope of the upper wall is less than a slope of the lower wall.

4. The combination according to claim 3, wherein the wrap edge receiving channel has a cross section having a C-shape or a V-shape or a U-shape.

5. The combination according to claim 3, wherein the upper wall is oriented at an angle of between about 20° and about 30° relative to a horizontal plane.

6. The combination according to claim 5, wherein the lower wall is oriented at an angle of between about 20° and about 30° relative to a horizontal plane.

7. The combination according to claim 1, wherein the vehicle panel has a substantially constant thickness in a region of the wrap edge receiving channel.

8. The combination according to claim 1, wherein the first panel portion is positioned further outboard than the second panel portion such that liquid traveling along the first panel portion is diverted to the second panel portion along a flow path that bypasses the wrap edge receiving channel.

9. The combination according to claim 1, wherein a surface of the first panel portion is oriented to divert liquid from the first panel portion to the second panel portion along a flow path that bypasses the wrap edge receiving channel.

10. The combination according to claim 1, wherein at least a portion of the wrap edge receiving channel is not covered by either the first wrap sheet or the second wrap sheet.

11. The combination according to claim 10, wherein a gap is defined between the first edge and the second edge within the wrap edge receiving channel.

12. The combination according to claim 1, wherein at least a portion of the first edge of the first wrap sheet overlaps at least a portion of the second edge of the second wrap sheet in the wrap edge receiving channel, wherein the first wrap sheet is an upper wrap sheet.

13. The combination according to claim 1, wherein at least a portion of the second edge of the second wrap sheet overlaps at least a portion of the first edge of the first wrap sheet in eth wrap edge receiving channel, wherein the second wrap sheet is a lower wrap sheet.

14. The combination according to claim 1, wherein the vehicle panel is a vehicle driver door, or a vehicle passenger door or a vehicle fender.

15. The combination according to claim 1, wherein the vehicle panel is a vehicle tailgate of a pickup truck or SUV.

16. The combination according to claim 14, wherein the vehicle tailgate further comprises a second wrap edge receiving channel extending at least partially along the vehicle tailgate, the second wrap edge receiving channel being positioned lower on the vehicle than the wrap edge receiving channel.

17. The combination according to claim 16, wherein the combination further comprises a third wrap sheet, and wherein each of the wrap edge receiving channel and the second wrap edge receiving channel is configured to receive two wrap sheet edges.

18. The combination according to claim 1, wherein the vehicle panel is a vehicle hood of a pickup truck or SUV, wherein the vehicle hood comprises three wrap edge receiving channels, wherein the combination comprises four wrap sheets, wherein one of the wrap edge receiving channels is configured to receive edges of four wrap sheets.

19. The combination according to claim 18, wherein two of the wrap edge receiving channels are parallel to each other and orthogonal to a third wrap edge receiving channel.

20. A method of at least partially covering the vehicle panel with the first wrap sheet and the second wrap sheet of the combination according to claim 1, wherein the method comprises:
adhering the first wrap sheet to the first panel portion of the vehicle panel and extending the first edge of the first wrap sheet into the wrap edge receiving channel;
adhering the second wrap sheet to the second panel portion of the vehicle panel and extending the second edge of the second wrap sheet into the wrap edge receiving channel.
